(19) United States
(12) Patent Application Publication
(10) Pub. No.: US 2026/0371433 A1
(43) Pub. Date: Nov. 19, 2026

(54) METHOD PERFORMED BY USER EQUIPMENT, AND USER EQUIPMENT

(71) Applicant: Sharp Kabushiki Kaisha, Sakai City, Osaka (JP)

(72) Inventors: Chongming ZHANG, Shanghai (CN); Renmao LIU, Shanghai (CN)

(21) Appl. No.: 19/138,762

(22) PCT Filed: Dec. 13, 2023
(86) PCT No.: PCT/CN2023/138401

§ 371 Date: Jun. 13, 2025

(30) Foreign Application Priority Data
Dec. 14, 2022 (CN) 202211636998.5

(51) Int. Cl. H04W 76/20; H04W 68/00

(52) U.S. Cl. CPC H04W 76/20; H04W 68/005

(57) ABSTRACT

The present invention provides a method performed by a user equipment, and a user equipment. The method is a method performed by a user equipment (UE) when carrying out a small data transmission (SDT) procedure, and includes the following steps: receiving, by the UE, a paging message, wherein the paging message carries a paging record, and the paging record comprises one or more UE identities; and initiating, by the UE, an RRC connection resumption procedure based on the paging message, and determining, by the UE in this procedure, whether a condition for performing small data transmission (SDT) is fulfilled.

### TECHNICAL FIELD

The present invention relates to the technical field of wireless communications, and in particular to a method performed by a user equipment, and a corresponding user equipment.

### BACKGROUND ART

To shorten transmission latency and to reduce signaling overhead, a UE entering an RRC inactive state may transmit, on a preconfigured uplink resource (Configured Grant Resource, CG), a transport block having a predetermined size and carrying data. Such transmission may be referred to as small data transmission (SDT). Considering that the UE triggers small data transmission due to arrival of uplink data, such small data transmission may be referred to as mobile originated small data transmission (MO-SDT).

Upon arrival of uplink data, the UE in the inactive state may determine whether a CG resource is valid, and if so, may transmit uplink data on the CG.

The UE may also receive a paging message sent by a network layer, the paging message instructing the UE to trigger or perform small data transmission. Small data transmission performed in this way is referred to as mobile terminal small data transmission (MT-SDT) in order to be distinguished from small data transmission triggered by arrival of uplink data. Based on an indication received by the UE in the paging message, the UE may initiate an RRC resumption procedure and perform a random access procedure in this procedure.

An uplink timing advance timer corresponding to a CG in a valid state (CG-TA timer) is in a running state. Once the timer expires, the UE flushes a HARQ buffer. Such a fixed operation may affect ongoing MT-SDT. How to avoid such an erroneous operation is a problem to be solved.

### SUMMARY OF THE INVENTION

In view of the above problem in the prior art, an objective of the present invention is to provide a method performed by a user equipment and capable of reliably performing small data transmission without erroneous operations, and a user equipment.

According to one aspect of the present disclosure, provided is a method performed by a user equipment, being a method performed a user equipment (UE) when carrying out a small data transmission (SDT) procedure, comprising the following steps:
Receiving, by the UE, a paging message, wherein the paging message carries a paging record, and the paging record comprises one or more UE identities; and
Initiating, by the UE, an RRC connection resumption procedure based on the paging message, and determining, by the UE in this procedure, whether a condition for performing small data transmission (SDT) is fulfilled.

In the described method performed by a user equipment, preferably,

When a UE identity matches a radio network temporary identifier (RNTI) stored by the UE, the UE initiates the RRC connection resumption procedure.

In the described method performed by a user equipment, preferably,

The UE identity is further associated with an indication to perform small data transmission, and the UE performs small data transmission based on the indication.

In the described method performed by a user equipment, preferably,

If the condition for performing SDT is fulfilled, the UE considers that the resumption procedure is initiated for SDT, and then the UE further determines whether the SDT is mobile terminal small data transmission (MT-SDT), and if the SDT is MT-SDT, the UE instructs a MAC entity of the UE to stop a running timer, wherein the timer is a timer associated with a configured grant (CG) resource.

In the described method performed by a user equipment, preferably,

In a process of initiating the RRC resumption procedure, the UE determines whether a condition for performing mobile terminal small data transmission (MT-SDT) is fulfilled, and if the condition for performing MT-SDT is fulfilled, the UE considers that the resumption procedure is initiated for SDT, and instructs a MAC entity of the UE to stop a running timer, wherein the timer is a timer associated with a configured grant (CG) resource.

In the described method performed by a user equipment, preferably,

When a radio resource control (RRC) layer of the UE initiates SDT and indicates to a media access control (MAC) layer that the SDT is MT-SDT, the UE selects a random access resource for the MT-SDT at the MAC layer, and

After selecting the random access resource for the MT-SDT, the UE considers the timer as expired and indicates to the RRC layer that the condition for initiating MT-SDT is fulfilled.

In the described method performed by a user equipment, preferably,

After selecting the random access resource for the MT-SDT, the UE further determines whether the configured CG resource is valid.

In the described method performed by a user equipment, preferably,

The UE obtains valid reference signal received power (RSRP) values, i.e., an RSRP value downlink pathloss reference saved by the UE, and an RSRP value of current downlink pathloss reference, and

If a fluctuation of the RSRP value of the current downlink pathloss reference does not exceed a pre-configured threshold in comparison with the RSRP value of the downlink pathloss reference saved by the UE, it is considered that the CG resource is valid.

In the described method performed by a user equipment, preferably,
when selecting the random access resource for the MT-SDT at the MAC layer, the UE first selects a carrier, and then determines the random access resource on the selected carrier, and
if no CG resource is configured on the selected carrier, after selecting the random access resource for the MT-SDT, the UE considers the timer as expired and indicates to the RRC layer that the condition for initiating MT-SDT is fulfilled; or
if a CG resource is configured on the selected carrier, after selecting the random access resource for the MT-SDT, the UE further determines whether the configured CG resource is valid.

According to another aspect of the present disclosure, provided is a user equipment, comprising: a processor; and a memory storing instructions, wherein the instructions, when run by the processor, cause the user equipment to perform the method described above.

### Effect of Invention

According to the method performed by a user equipment and the user equipment of the present disclosure, even if an uplink timing advance timer corresponding to an uplink resource (CG) expires in a process of performing small data transmission, a conventional fixed operation like flushing a HARQ buffer is not performed, but determination is first performed instead. In this way, the described erroneous operations can be avoided, thereby reliably performing small data transmission.

### BRIEF DESCRIPTION OF THE DRAWINGS

FIG. 1 is a flowchart showing a method performed by a user equipment according to an embodiment of the present invention.

FIG. 2 is a structural block diagram illustrating a user equipment according to the present invention.

### DETAILED DESCRIPTION OF PREFERRED EMBODIMENTS

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

Prior to the specific description, several terms mentioned in the present invention are illustrated as follows. The terms involved in the present invention shall have the meanings set forth below, unless otherwise indicated:
UE: User Equipment
NR: New Radio
LTE: Long Term Evolution
eLTE: Enhanced Long Term Evolution
RRC: Radio Resource Control (layer)
MAC: Medium Access Control (layer)
MAC CE: MAC Control Element
RNTI: Radio Network Temporary Identifier
C-RNTI MAC CE: Cell Radio Network Temporary Identifier MAC Control Element
LCID: Logical Channel Identity
PDU: Protocol Data Unit
SDU: Service Data Unit
RLC: Radio Link Control (layer)
PDCP: Packet Data Convergence Protocol (layer)
MAC SDU: MAC Protocol Data Unit
MAC PDU: MAC Protocol Data Unit
DCI: Downlink Control Information
DCCH: Dedicated Control Channel
DRB: Data Radio Bearer
SRB: Signaling Radio Bearer
SDT: Small Data Transmission
RSRP: Reference Signal Receiving Power

A plurality of embodiments according to the present invention are specifically described below, with an NR mobile communications system and its subsequent evolved version serving as exemplary application environments, and with a base station and UE that support NR serving as examples. However, it should be noted that the present invention is not limited to the following embodiments, but is applicable to other wireless communications systems, such as an eLTE communication system, or an NB-IoT system, or an LTE-M system. Moreover, the present invention may be applicable to other base stations and user equipment, such as base stations and user equipment supporting eLTE/NB-IoT/LTE-M.

### Small Data Transmission

Small data herein mainly refers to data having a size which does not exceed a predetermined value, or a packet that carries said data (e.g. a MAC PDU/RLC PDU/PDCP PDU carrying the data) having a size which does not exceed a predetermined value. This value may be broadcast by a base station or a network side in system information. When a UE determines that the size of the data or data packet to be sent does not exceed this value, the UE can directly send the data or data packet to the base station or the network side through a random access procedure or a pre-configured uplink resource, without having to undergo the process of entering an RRC connected state first and then performing data transmission. That is, small data transmission is a way for a UE to transmit data in an inactive state. The type of data herein mainly refers to user plane data (UP data). Control plane data (CP data) may also be transmitted in this way.

Small data transmission triggered by the UE due to arrival of uplink data may be referred to as mobile originated small data transmission (MO-SDT).

The UE may also receive a paging message sent by a network layer, the paging message instructing the UE to trigger or perform small data transmission. Small data transmission performed in this way is referred to as mobile terminal small data transmission (MT-SDT) or paging based SDT, in order to be distinguished from small data transmission triggered by arrival of uplink data.

To perform small data transmission, the UE needs to initiate an RRC connection resumption procedure (RRC resumption procedure), and such an RRC connection resumption procedure may be referred to as an SDT triggered RRC connection resumption procedure, or an RRC connection resumption procedure initiated for SDT. Such an RRC connection resumption procedure may be further classified into an MO-SDT triggered or MT-SDT triggered RRC connection resumption procedure. In the RRC connection resumption procedure, the UE transmits an RRC connection resume request message to the base station or the network side, and then waits for response information from the network side. Specifically, for an MT-SDT triggered RRC connection resumption procedure, the UE may indicate, in the transmitted RRC connection resume request message, that a triggering cause value corresponds to MT-SDT. In this way, the base station or the network side knows that this procedure is an MT-SDT triggered RRC connection resumption procedure.

After initiating the described RRC connection resumption procedure, the UE may determine whether a condition for performing SDT transmission is fulfilled. The condition may be as follows:
The UE is configured with radio bearers applicable to SDT;
Data to be transmitted is mapped to the radio bearers applicable to SDT;
The UE is configured with configuration parameters corresponding to SDT;
The UE receives an SDT indication in a paging message; or
A lower layer (e.g., below an RRC layer) of the UE indicates that a condition for initiating SDT is fulfilled.

When some or all of these conditions are fulfilled, the UE may consider that the condition for performing SDT transmission is fulfilled.

Certainly, the present disclosure is not limited to the described conditions, and another limiting condition may be used. Emphasized herein is an operation performed by the UE when the condition for performing SDT transmission is fulfilled.

### Configured Grant

Configured grant (CG) resources refer to a set of periodic uplink resources that do not need to be dynamically scheduled. The UE may send uplink data on the CG resources. The CG resources are usually associated with a timer cg-SDT-TimeAlignmentTimer, and a MAC entity may use this timer to determine whether uplink transmission is uplink time synchronized or aligned. Typically, during running of this timer, the UE or the MAC entity of the UE may consider that uplink transmission is synchronized, and a timing advance used by the UE is valid. If this timer stops running or expires, the UE does not perform transmission on uplink resources corresponding thereto because uplink may not be synchronized at this time, and result in a transmission failure.

To solve the problem in the prior art, several embodiments of the present invention are described in detail below, but the following embodiments are merely examples provided for easy understanding of the present invention, and do not limit the present invention.

Specific examples are provided below to describe the present invention.

### Embodiment 1

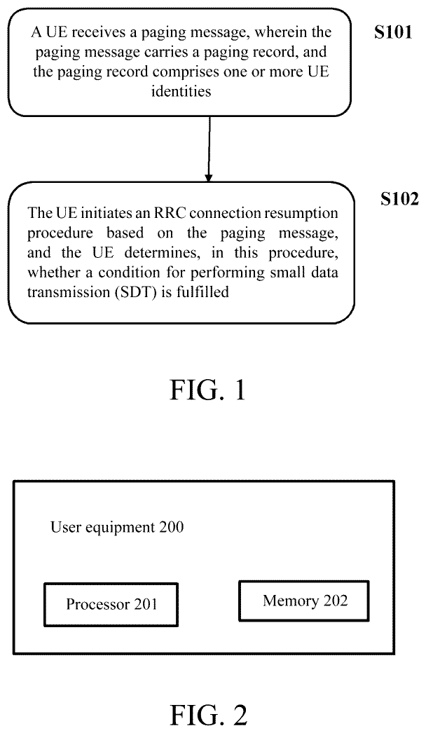

This embodiment provides a method performed by a user equipment (UE), which is specifically a method performed by a UE when carrying out a small data transmission (SDT) procedure. As shown in FIG. 1, the method includes the following steps.

Step 1 (S101): The UE receives a paging message, wherein the paging message carries a paging record, and the paging record includes one or several UE identities. When a UE identity matches an RNTI stored by the UE, the UE may initiate an RRC connection resumption procedure. Preferably, the UE identity may be further associated with an indication to perform small data transmission, and the UE may perform small data transmission based on the indication. Since such a small data transmission procedure is triggered or caused by a small data transmission indication carried in a paging message, such small data transmission may be referred to as MT-SDT. Small data transmission relies on an RRC connection resumption procedure, and therefore it may be considered that this RRC connection resumption procedure is triggered by MT-SDT.

Step 2 (S102): The UE initiates an RRC connection resumption procedure based on the paging message in step 1, and determines, in this procedure, whether a condition for performing small data transmission is fulfilled.

In a case where the condition for performing small data transmission is fulfilled, the UE may consider that this resumption procedure is initiated for SDT, and then the UE may further determine whether the SDT is MT-SDT, and if so, the UE instructs a MAC entity of the UE to stop a cg-SDT-TimeAlignmentTimer if it is running. Accordingly, if the SDT is not MT-SDT, the indicated operation does not need to be performed.

Additionally, if the condition for performing small data transmission cannot be fulfilled, the UE may still perform an RRC connection resumption procedure, except that this procedure is not initiated for SDT.

### Another Implementation may be as Follows

The UE initiates an RRC resumption procedure. During this procedure, the UE determines whether a condition for performing MT-SDT is fulfilled. When the condition for performing MT-SDT is fulfilled, it may be considered that this resumption procedure is initiated for SDT, and the UE instructs a MAC entity of the UE to stop a cg-SDT-TimeAlignmentTimer if it is running.

Preferably, this embodiment is performed at an RRC layer of a UE.

### Embodiment 2

A difference between this embodiment and Embodiment 1 lies in that the UE can perform an operation at a MAC layer to solve the problem.

Specifically, when an upper layer (which is mainly above the MAC layer, e.g., an RRC layer) of the UE initiates SDT, the upper layer preferentially initiates MT-SDT. For example, when initiating SDT, the upper layer may indicate to the MAC layer that the initiated SDT is MT-SDT, that is, the initiated SDT is triggered by paging. In this case, the UE may select a random access resource for the MT-SDT at the MAC layer.

After selecting the random access resource for the MT-SDT, the UE may consider a timer cg-SDT-TimeAlignmentTimer as expired, and indicate to the upper layer (e.g., the RRC layer) that the condition for initiating an SDT procedure is fulfilled, and preferably indicate to the upper layer that a condition for initiating MT-SDT is fulfilled.

When the UE considers the timer cg-SDT-TimeAlignmentTimer as expired, the UE may correspondingly perform one or more of the following operations:
Flushing HARQ buffers;
Maintaining timing advance related parameter values; and
Clearing one or more configured uplink grants.

Additionally, if the UE does not select a random access resource for the MT-SDT, the UE does not need to process the timer cg-SDT-TimeAlignmentTimer or does not consider the timer cg-SDT-TimeAlignmentTimer as expired.

### Embodiment 3

Based on Embodiment 1 or 2, the UE may further determine whether a CG resource is valid. A specific implementation manner may be as follows:

When an upper layer (which is mainly above the MAC layer, e.g., the RRC layer) of the UE initiates SDT, the upper layer preferentially initiates MT-SDT. For example, when initiating SDT, the upper layer may indicate to the MAC layer that the initiated SDT is MT-SDT, that is, the initiated SDT is triggered by paging. In this case, the UE selects a random access resource for the MT-SDT at the MAC layer.

After selecting the random access resource for the MT-SDT, the UE may further determine whether a configured CG resource is valid. Preferably, when the timer cg-SDT-TimeAlignmentTimer is running, the UE may determine whether the configured CG resource is valid, and perform the following operations according to a determination result. It should be noted that if the timer cg-SDT-TimeAlignmentTimer is not running, the CG resource is definitely invalid, and therefore the following determination operations are not required:
If the UE determines that the CG resource is valid, the UE may not need to process the timer cg-SDT-TimeAlignmentTimer or may not consider the timer cg-SDT-TimeAlignmentTimer as expired; or
If the UE determines that the CG resource is invalid, the UE may consider the timer cg-SDT-TimeAlignmentTimer as expired.

When the UE considers the timer cg-SDT-TimeAlignmentTimer as expired, the UE may correspondingly perform one or more of the following operations:
Flushing HARQ buffers;
Maintaining timing advance related parameter values; and
Clearing one or more configured uplink grants.

Then, the UE may indicate to the upper layer (e.g., the RRC layer) that the condition for initiating an SDT procedure is fulfilled, and preferably indicate to the upper layer that the condition for initiating MT-SDT is fulfilled.

Determining whether a CG resource is valid may include the following operations:

First, the UE may obtain valid RSRP values, wherein the RSRP values are an RSRP value of downlink pathloss reference saved by the UE, and an RSRP value of current downlink pathloss reference;

Then, a fluctuation (i.e., an incremental amount or a decremental amount) of the RSRP value of the current downlink pathloss reference does not exceed a pre-configured threshold in comparison with the RSRP value of the downlink pathloss reference saved by the UE.

If the UE does not have a valid RSRP value (i.e., does not have saved the RSRP value of the downlink pathloss reference, or cannot obtain the RSRP value of the current downlink pathloss reference), or if the fluctuation of the RSRP value of the current downlink pathloss reference is too large and is greater than the threshold, it may be considered that the CG resource is invalid.

### Embodiment 4

When selecting the random access resource for the MT-SDT at the MAC layer, the UE needs to select a carrier first, and then determine the random access resource on the selected carrier.

If no CG resource is configured on the chosen/selected carrier, as described in Embodiment 2, after selecting the random access resource for the MT-SDT, the UE may consider the timer cg-SDT-TimeAlignmentTimer as expired, and indicate to the upper layer (e.g., the RRC layer) that the condition for initiating an SDT procedure is fulfilled, and preferably indicate to the upper layer that the condition for initiating MT-SDT is fulfilled.

If a CG resource is configured on the selected carrier, as described in Embodiment 3, after selecting the random access resource for the MT-SDT, the UE may further determine whether the configured CG resource is valid, and perform a corresponding operation according to a determination result.

This embodiment may be combined with the foregoing embodiments for operations.

### Embodiment 5

A user equipment (UE) according to the present disclosure is briefly described with reference to FIG. 2. FIG. 2 is a simplified structural block diagram of a user equipment (UE) according to the present invention. As shown in FIG. 2, the user equipment 200 includes a processor 201 and a memory 202. The processor 201 may include, for example, a microprocessor, a microcontroller, an embedded processor, and the like. The memory 202 may, for example, include a volatile memory (for example, a random access memory (RAM)), a hard disk drive (HDD), a non-volatile memory (for example, a flash memory), or other memories. The memory 202 has program instructions stored thereon. The instructions, when run by the processor 201, may perform the method performed by a user equipment as described above in detail in the present invention.

The program running on the device according to the present invention may be a program that enables the computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing the programs by a computer system. The so-called “computer system” may be a computer system embedded in the device, which may include operating systems or hardware (for example, peripherals). The “computer-readable recording medium” may be a semiconductor recording medium, an optical recording medium, a magnetic recording medium, a short-time dynamic memory program recording medium, or any other recording medium readable by a computer.

Various features or functional modules of the device used in the above embodiments may be implemented or executed via circuits (for example, monolithic or multi-chip integrated circuits). Circuits designed to execute the functions described in the present specification may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-10. (canceled)

11. A user equipment (UE), comprising:
a processor; and
a memory in electronic communication with the processor, wherein instructions stored in the memory are executable to:
receive a paging message including a UE identity;
when the UE identity matches a Radio Network Temporary Identifier (RNTI) stored by the UE, and the paging message includes a Small Data Transmission (SDT) indicator associated with the UE identity,
initiate, by an upper layer, a Radio Resource Control (RRC) connection resumption procedure for mobile terminal SDT (MT SDT),
in response to initiating the RRC connection resumption procedure for the MT SDT,
consider, by a Medium Access Control (MAC) layer, a timer as expired, and
indicate, by the MAC layer, to the upper layer that a condition for initiating an SDT procedure is fulfilled, wherein
in response to considering the timer as expired,
the MAC layer clears configured uplink grants, and
the MAC layer flushes HARQ buffers.

12. A base station communicating with a user equipment (UE), the base station comprising:
a processor; and
a memory in electronic communication with the processor, wherein instructions stored in the memory are executable to:
transmit a paging message including a UE identity and a Small Data Transmission (SDT) indicator associated with the UE identity, wherein
when the UE identity matches a Radio Network Temporary Identifier (RNTI) stored by the UE,
an upper layer of the UE initiates a Radio Resource Control (RRC) connection resumption procedure for mobile terminal SDT (MT SDT),
in response to initiating the RRC connection resumption procedure for the MT SDT,
a Medium Access Control (MAC) layer of the UE considers a timer as expired, and
the MAC layer of the UE indicates to the upper layer that a condition for initiating an SDT procedure is fulfilled, and
in response to considering the timer as expired,
the MAC layer of the UE clears configured uplink grants, and
the MAC layer of the UE flushes HARQ buffers.

13. A control method in a user equipment (UE), comprising:
receiving a paging message including a UE identity;
when the UE identity matches a Radio Network Temporary Identifier (RNTI) stored by the UE, and the paging message includes a Small Data Transmission (SDT) indicator associated with the UE identity,
initiating, by an upper layer, a Radio Resource Control (RRC) connection resumption procedure for mobile terminal SDT (MT SDT),
in response to initiating the RRC connection resumption procedure for the MT SDT,
considering, by a Medium Access Control (MAC) layer, a timer as expired, and
indicating, by the MAC layer, to the upper layer that a condition for initiating an SDT procedure is fulfilled, wherein
in response to considering the timer as expired,
the MAC layer clears configured uplink grants, and
the MAC layer flushes HARQ buffers.
